(19) United States
(12) Patent Application Publication
(10) Pub. No.: US 2016/0203140 A1
(43) Pub. Date: Jul. 14, 2016

(54) METHOD, SYSTEM, AND USER INTERFACE FOR EXPERT SEARCH BASED ON CASE RESOLUTION LOGS

(71) Applicant: General Electric Company, Schenectady, NY (US)

(72) Inventor: Sharoda Aurushi Paul, Dublin, CA (US)

(21) Appl. No.: 14/597,023

(22) Filed: Jan. 14, 2015

(51) Int. Cl. G06F 17/30

(52) U.S. Cl. CPC G06F 17/3053; G06F 17/30554

(57) ABSTRACT

Aspects of the present disclose involve a system comprising a computer-readable storage medium storing at least one program, and a method for finding experts based on case resolution logs. In example embodiments, the method may include extracting a plurality of topics from case resolution logs and using the extracted topics to model the relationship between experts and received user queries in order to identify experts with the most relevant expertise with respect to the user queries. The method may further include presenting an expert selection interface that includes a list of the identified experts and information about the experts to assist users in the expert selection decision.

### TECHNICAL FIELD

The subject matter disclosed herein relates to data processing. In particular, example embodiments may relate to techniques for finding experts to resolve problems encountered in industrial settings.

### BACKGROUND

Enterprise employees often need to find experts within the enterprise to obtain information on a topic, to find a person with specific skills for projects, or to find advice on solving a particular problem. With the proliferation of mobile devices in the enterprise, technicians performing equipment maintenance (e.g. during a planned outage at a power plant) often need to engage in real-time collaborative troubleshooting with remote experts. A key aspect of collaborative troubleshooting is finding the right expert for a given problem.

A traditional technique for expert identification is the candidate-based approach, which involves building a profile for a candidate expert based on the relevance of the information generated by the candidate expert to a user query. Another approach traditionally employed is the document-based approach in which all documents relevant to a user's query are retrieved, and links between the documents and the authors of the documents are discovered.

### BRIEF DESCRIPTION OF THE DRAWINGS

Various ones of the appended drawings merely illustrate example embodiments of the present inventive subject matter and cannot be considered as limiting its scope.

FIG. 1 is a network architecture diagram depicting an enterprise network system having a client-server architecture configured for exchanging data over a network, according to some example embodiments.

FIG. 2 is a block diagram illustrating various functional components of an expert identification application, which is provided as part of the enterprise network system, according to some example embodiments.

FIG. 3 is an interaction diagram depicting example exchanges between the functional components of the expert identification application while engaged in an expertise identification process, consistent with some example embodiments.

FIG. 4 is a flow chart illustrating a method for determining topic-based expertise of experts based on case resolution data, according to some embodiments.

FIG. 5 is a flowchart illustrating a method for identifying experts with expertise relevant to a user query, according to some example embodiments.

FIG. 6 is an interface diagram illustrating an expert selection interface, according to an example embodiment.

FIG. 7 is an interface diagram illustrating an expert selection interface, according to an alternative example embodiment.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Aspects of the present disclosure relate to techniques for expert identification and presentation. Example embodiments involve systems and methods that allow users, such as equipment technicians, to find experts relevant to a given problem by leveraging existing case resolution logs. In particular, the system extracts topics from the case resolution logs previously filed by technicians and resolved by experts. The system may then use the extracted topics to model the relationship between experts and received user queries in order to identify the experts with the most relevant expertise with respect to the user queries. In this manner, aspects of the present disclosure may provide the technical effect of reducing resources needed to maintain conventional directories and organization profiles by leveraging existing data generated as part of experts' formal job responsibilities. Furthermore, aspects of the present disclosure may provide the additional technical effect of reducing cycle time for issue resolution by enabling technicians to quickly find the correct expert at the site of the problem, and thus reduce the amount of down-time of failed or malfunctioning equipment.

Example embodiments involve a user interface operable to receive a user query comprising one or more keywords that describe a problem being encountered by the user. The system may then identify experts with the most relevant expertise to the problem through text mining of the case resolution logs. In turn, the user interface presents a ranked list of the relevant experts along with additional information about the experts to aid users' expert-selection decision. The additional information includes, for example, a taxonomy-based representation of domain expertise, information related to experience with related cases, approachability information and availability indicators.

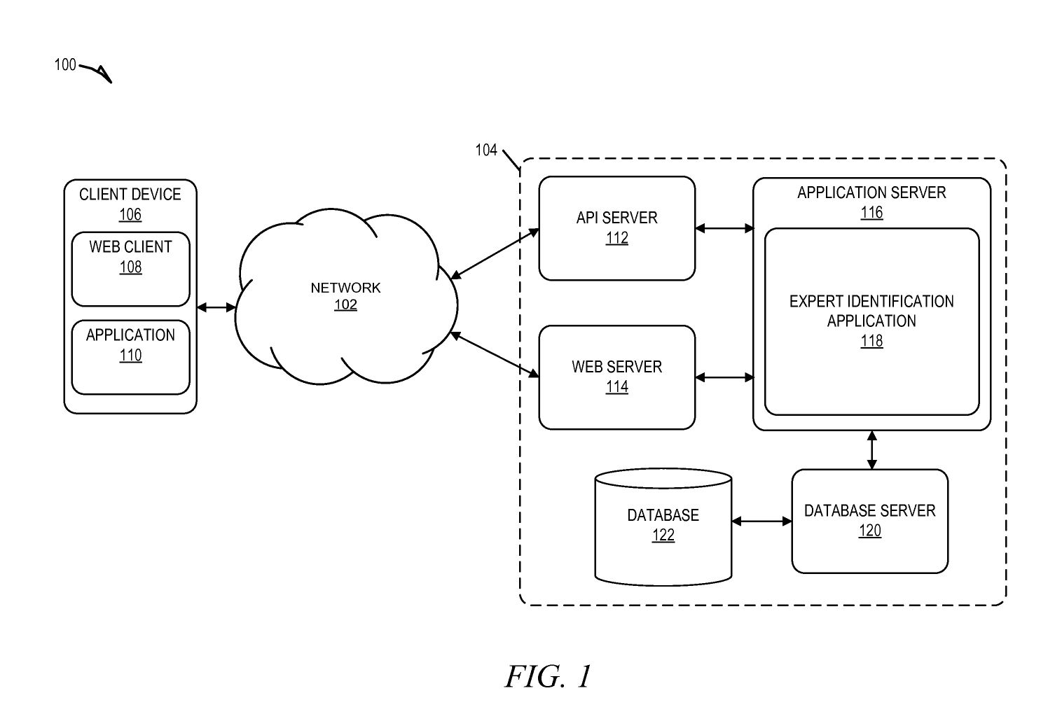

FIG. 1 is a network architecture diagram depicting an enterprise network environment 100 having a client-server architecture configured for exchanging data over a network 102, according to some example embodiments. To avoid obscuring the inventive subject matter with unnecessary detail, various functional components (e.g., modules and engines) that are not germane to conveying an understanding of the inventive subject matter have been omitted from FIG. 1. However, a skilled artisan will readily recognize that various additional functional components may be supported by the enterprise network environment 100 to facilitate additional functionality that is not specifically described herein. Further, while FIG. 1 provides an example architecture that is consistent with some embodiments, the presented inventive subject matter is not limited to the architecture illustrated in FIG. 1, and may equally well find application in a an event-driven, distributed, or peer-to-peer architecture system, for example. It shall also be appreciated that, although various components of the enterprise network environment 100 are discussed in the singular sense, multiple instances of one or more of the various functional components may be employed.

The enterprise network environment 100 includes an enterprise system 104 in communication with a client device 106 over the network 102. The enterprise system 104 communicates and exchanges data within the enterprise network environment 100 that pertains to various functions and aspects associated with the enterprise network environment 100 and its users. The enterprise system 104 may provide server-side functionality, via the network 102 (e.g., the Internet), to the client device 106. The client device 106 may be operated by a user of the enterprise network environment 100 to exchange data over the network 102. The users of the enterprise network environment 100 may, for example, include engineers, technicians, or experts with machines or equipment deployed within the enterprise or other industrial domain. The data exchanges may include transmitting, receiving, and processing data to, from, and regarding content, users, and assets of the enterprise network environment 100.

The client device 106, which may be any of a variety of types of devices (e.g., a smart phone, a tablet computer, a personal digital assistant (PDA), a personal navigation device (PND), a handheld computer, a desktop computer, a laptop or netbook, a wearable computing device, a Global Positioning System (GPS) device, a data enabled book reader, or a video game system console), may interface via a connection with the communication network 102. Depending on the form of the client device 106, any of a variety of types of connections and communication networks 102 may be employed. For example, in various embodiments, the network 102 may include one or more wireless access points coupled to a local area network (LAN), a wide area network (WAN), the Internet, or other packet-switched data network. In some embodiments, the network 102 may, itself, be a LAN, a WAN, the Internet, or other packet-switched data network. Accordingly, a variety of different configurations are expressly contemplated.

In various embodiments, the data exchanged within the enterprise network environment 100 may be dependent upon user-selected functions available through one or more client or user interfaces (UIs). The UIs may, for example, be specifically associated with a web client 108 (e.g., a browser) executing on the client device 106, and in communication with the enterprise system 104. The UIs may also be associated with an application 110 executing on the client device 106, such as a client application designed for interacting with the enterprise system 104. The application 110 may, for example, provide users with the ability to compose and transmit search queries to identify experts to assist in resolving problems encountered in the field.

Turning specifically to the enterprise system 104, an API server 112 and a web server 114 are coupled to (e.g., via wired or wireless interfaces), and provide programmatic and web interfaces respectively to, an application server 116. The application server 116 may, for example, host one or more applications, such as an expert identification application 118. The expert identification application 118 assists users in identifying experts to resolve problems encountered in the field. To this end, the expert identification application 118 is designed to receive a user query describing a problem, and return a list of experts with expertise related to the problem.

As illustrated in FIG. 1, the application server 116 is coupled to a database server 120 that facilitates access to a database 122. However, in some example embodiments, the application server 116 can access the database 122 directly without the need for the database server 120. Further, the database 122 may include multiple databases that may be internal or external to the enterprise system 104. The database 122 stores data pertaining to various functions and aspects associated with the enterprise network environment 100 and its users. For example, the database 122 may store and maintain a plurality of user records for users of the enterprise network environment 100 (e.g., engineers, technicians, or experts). The user records may include information about the users such as a name, a title, a location, a number of years of experiences, assigned cases, resolved cases, availability information, and approachability information, among other things.

The database 122 further stores case resolution data. The case resolution data comprises a plurality of existing case resolution logs previously prepared by technicians. Each case resolution log corresponds to a case that involves a past problem encountered in an industrial domain such as in the context of a power plant. Each case has a corresponding expert to which the case was assigned. Each of the case logs includes textual information concerning the resolution of the case by the assigned expert. Further, each case log may include one or more taxonomy case tags to assist in indexing and locating cases in the system.

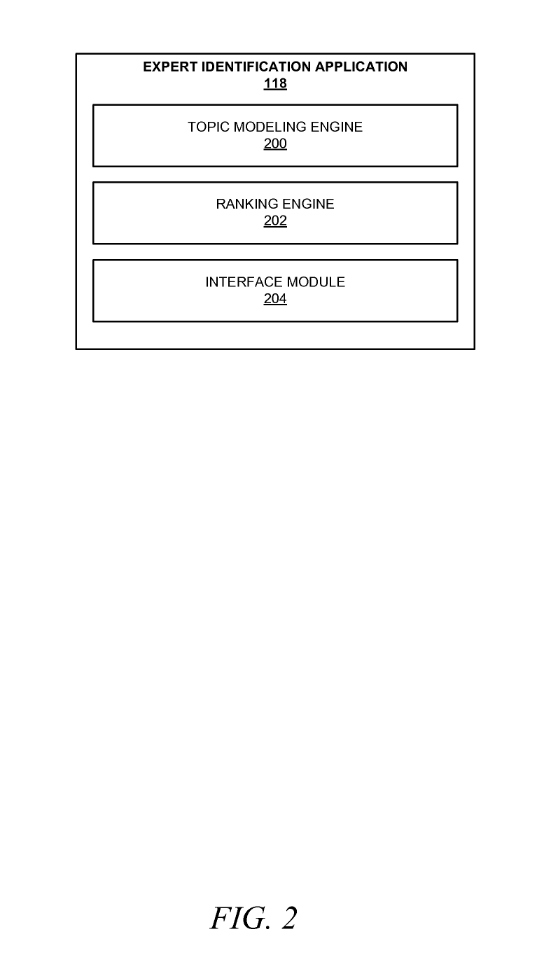

FIG. 2 is a block diagram illustrating various functional components of the expert identification application 118, which is provided as part of the enterprise system 104, according to some example embodiments. As is understood by skilled artisans in the relevant computer and Internet-related arts, the modules and engines illustrated in FIG. 2 represent a set of executable software instructions and the corresponding hardware (e.g., memory and processor) for executing the instructions. Furthermore, the various functional components depicted in FIG. 2 may reside on a single computer (e.g., a server), or may be distributed across several computers in various arrangements such as cloud-based architectures. Moreover, it shall be appreciated that while the functional components (e.g., modules and engines) of FIG. 2 are discussed in the singular sense, in other embodiments, multiple instances of one or more of the modules may be employed.

As illustrated in FIG. 2, the expert identification application 118 includes a topic modeling engine 200, a ranking engine 202, and an interface module 204, all configured to be in communication with each other (e.g., via a bus, a shared memory, a network 102, or a switch) so as to allow information to be passed between the functional components or so as to allow the functional components to share and access common data. Additionally, each of the functional components illustrated in FIG. 2 may access and retrieve data from the database 122, and each of the functional components may be capable of communication with the other components of the enterprise network environment 100 (e.g., client device 106).

The topic modeling engine 200 may be configured to determine how likely a given candidate (e.g., an expert who has previously resolved a problem) is an expert on a received user search query. Consistent with some embodiments, the topic modeling engine 200 may make this determination based on the probability that candidate ca is an expert on the input query q, which will be denoted for purposes of the following explanation as P(ca|q). Per Bayes Theorem, P(ca|q) may be calculated as follows:

$$P ( ca \text{\textbar} q ) = \frac{P ( q \text{\textbar} ca ) P ( ca )}{P ( q )}$$

where P(ca|q) is the probability of candidate ca generating the query q; P(ca) is the prior probability of candidate ca, and P(q) is the probability of query q. Considering that P(q) is constant and P(ca) is a uniform distribution over all candidates, P(ca|q) depends primarly on P(q|ca).

To calculate P(q|ca), the topic modeling engine 200 may use topics as hidden variables to model the relationship between user queries and experts. Consistent with some embodiments, the topic modeling engine 200 may use a topic modeling technique (e.g., Latent Dirichlet Allocation (LDA)) that models documents as a mixture of topics and represents each topic as a probability distribution over words. The topic modeling engine 200 may use the extracted topics to model the relationship between candidates and words in the query. In this way, each problem that may occur in the field, as expressed by a received user query, may be viewed as a mixture of topics. Accordingly, the topic modeling engine 200 may calculate the probability of candidate ca generating the query as follows:

$$P ( q \text{\textbar} ca ) = {\prod }_{w ∈ q} ( {\sum }_{t ∈ T} P ( w \text{\textbar} t ) P ( t \text{\textbar} ca ) )$$

Where P(w|t) is the probability of word w belonging to topic t, and P(t|ca) is the probability of expert ca generating topic t.

The ranking engine 202 may be configured to rank candidates according to the probability that the candidate is an expert on a received user query, as determined by the topic modeling engine 200. The ranking engine 202 may further select a subset of the identified experts (e.g., the top three ranked experts) for presentation in response to receiving the user search query.

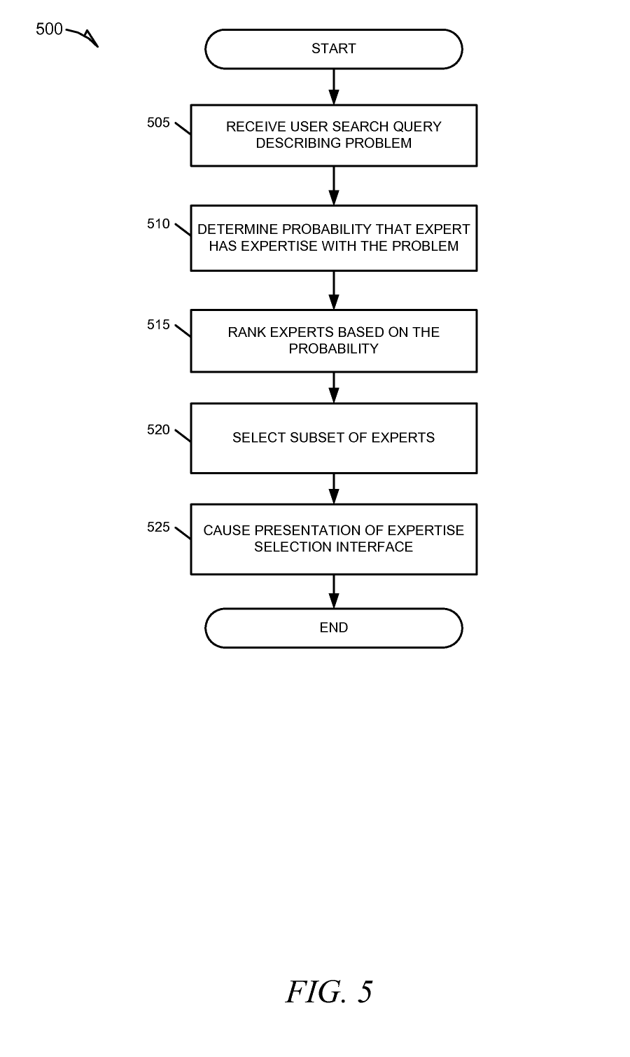

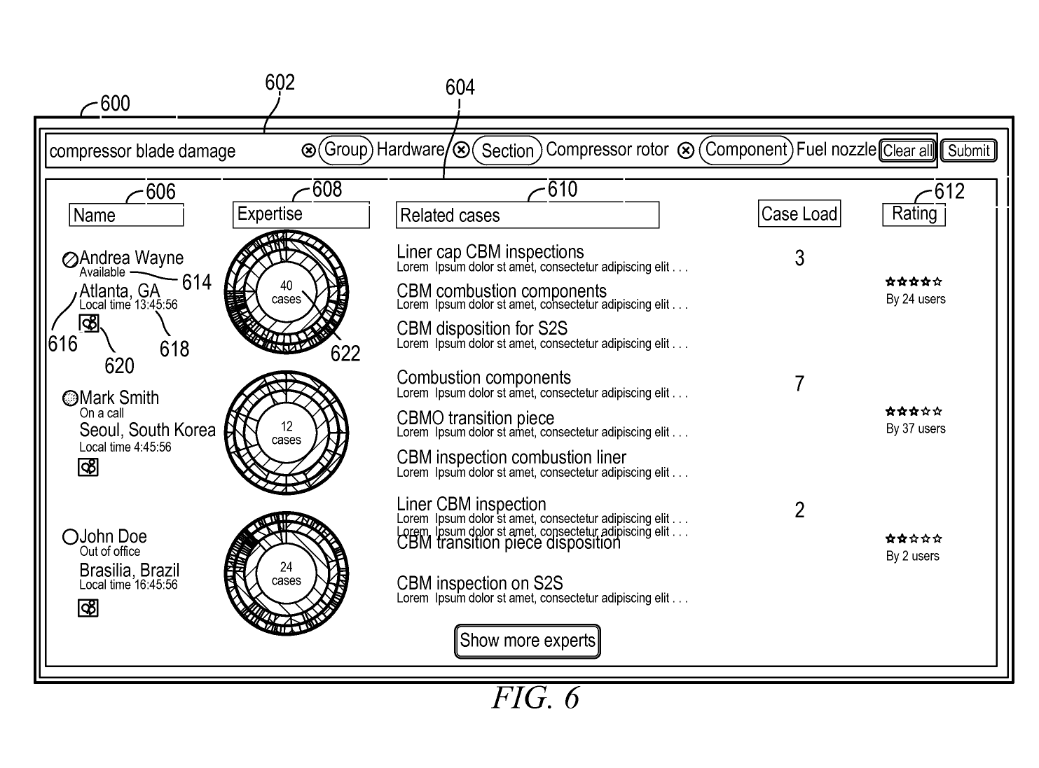

The interface module 204 is responsible for presenting user interfaces to users. For example, the interface module 204 may transmit a set of instructions to the client device 106 that cause the client device 106 to present one or more user interfaces to a user. The interface module 204 may, for example, present an expert selection interface that is operable to receive a user search query describing a problem. Accordingly, the interface module 204 is further responsible for receiving and processing user input received by any one of the user interfaces presented by the interface module 204. The expert selection interface presented by the interface module 204 may further include a presentation of a list of experts identified as having expertise relevant the problems described by the received user queries. The presentation of the list of experts may further include information about each of the experts in order to aid users' expert-selection decision. Further information regarding the details of the expert selection interface, according to example embodiments, are discussed below in reference to FIGS. 5 and 6.

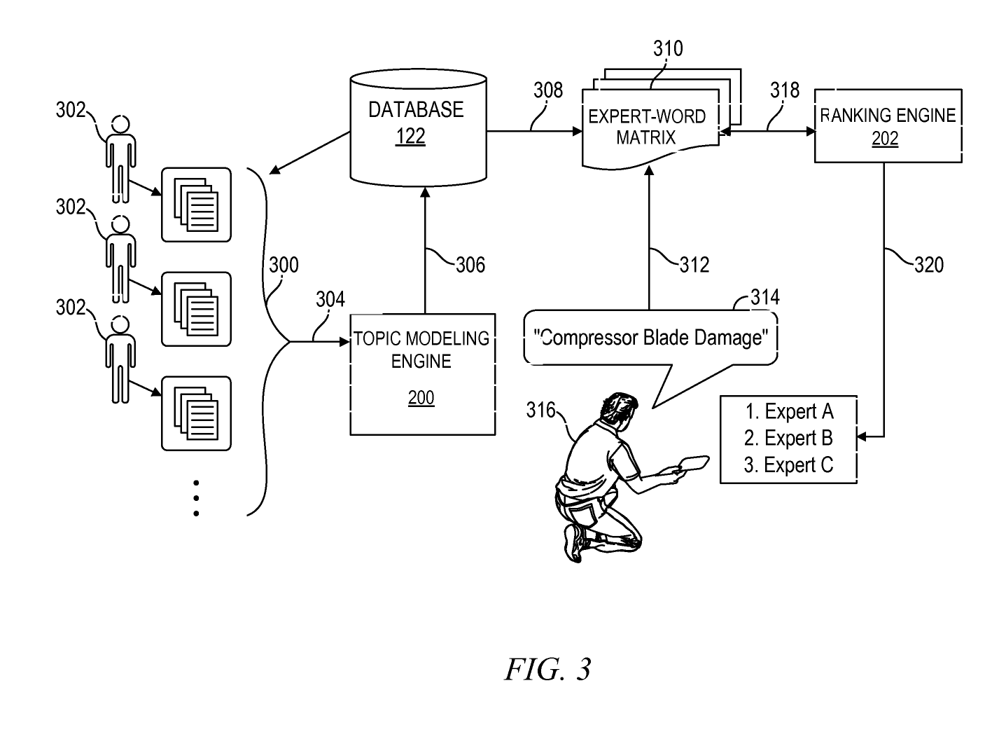

FIG. 3 is an interaction diagram depicting example exchanges between the functional components of the expert identification application 118 while engaged in an expertise identification process, consistent with some example embodiments. As shown, the topic modelling engine 200 obtains a corpus of case resolution data 300 from the database 122. The corpus of case resolution data 300 comprises a plurality of case resolution logs created by a plurality of technicians 302. Each of the case resolution logs includes textual information related to the resolution of a problem in an industrial domain by an assigned expert. The textual information may, for example, include a name of the technician that submitted the problem (also referred to herein as the “submitter”), a name of the expert to which the problem was assigned (also referred to herein as the “assignee”), a description of the problem including an identifier of equipment involved in the problem, if applicable, and a description of how the problem was resolved.

As shown, at operation 304 the topic modelling engine 200 mines the textual information included in the corpus of case resolution data 300 to identify latent topics. A record of each of the extracted topics is stored in the database 122 with an association to one or more words and one or more experts, at operation 306. At operation 308, the topic modelling engine 200 creates an expert-word matrix 310 using the extracted topics. The expert-word matrix 310 contains the probabilities P(w|ca) for all experts ca and all words w in the vocabulary, wherein P(w|ca) is the probability of a given expert being associated with (e.g., uttering) a word in the vocabulary. For purposes of this disclosure, the term “vocabulary” collectively refers to all unique words included in a corpus of case resolution data.

At operation 312, the interface module 204 (not shown) receives a user query 314 from a client device (e.g., client device 106) operated by technician 316. The received user query 314 describes a problem being encountered in an industrial setting. In some instances, the query 314 may pertain to a particular asset being utilized in the industrial domain. The asset may be a piece of machinery or equipment that is responsible for performing one or more functions within the industrial domain. The asset may take on one of a variety of forms including, for example, medical equipment, appliances, power equipment, aviation units, trains, vehicles, wind turbines, gas turbines or the like. In the example illustrated in FIG. 3, the user query 314 pertains to a “compressor blade,” and, in particular, “compressor blade damage.”

Upon receiving the user query 314 at operation 318, the topic modelling engine 200 accesses the expert-word matrix 310 to determine the probability P(q|ca) for all experts associated with the corpus of case resolution data 300, where P(q|ca) is the probability that the expert has expertise with the problem described by the user query 314. The ranking engine 202 then ranks all experts associated with the corpus of case resolution data 300 according to the probability that the expert has expertise with the problem described by the query 314. At operation 320, the interface module 204 (not shown) causes a list of the top ranked experts to be displayed on the client device 106 being operated by the technician 316.

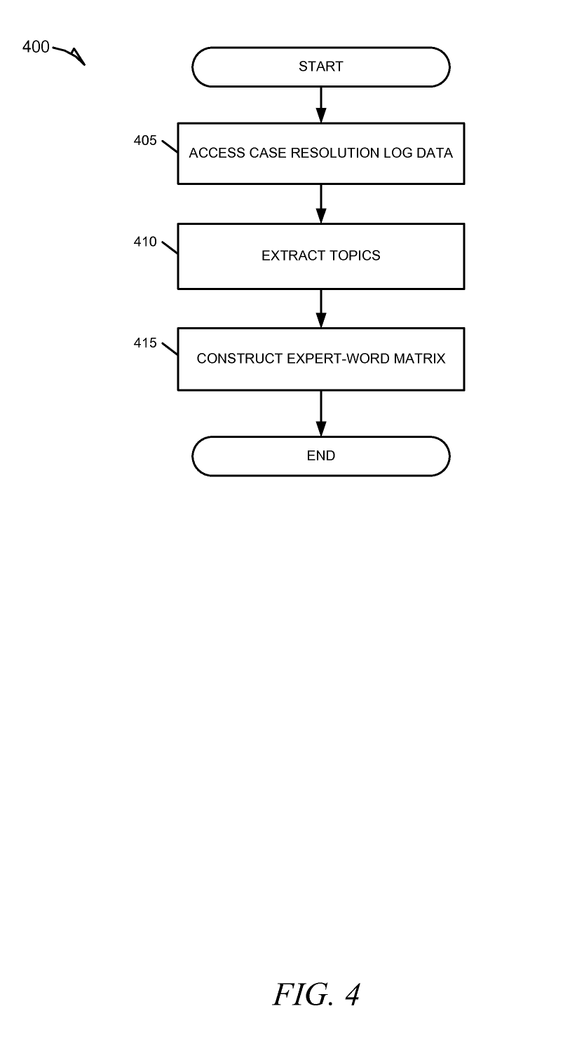

FIG. 4 is a flow chart illustrating a method 400 for determining topic-based expertise of experts based on case resolution data 300, according to some embodiments. The method 400 may be embodied in computer-readable instructions for execution by a hardware component (e.g., a processor) such that the steps of the method 400 may be performed in part or in whole by the functional components of the expert identification application 118, and accordingly, the method 400 is described below, by way of example with reference thereto. However, it shall be appreciated that the method 400 may be deployed on various other hardware configurations and is not intended to be limited to the expert identification application 118.

At operation 405, the topic modelling engine 200 accesses a corpus of case resolution data from the database 122. The case resolution data comprises a plurality of existing case resolution logs previously authored by technicians. Each case resolution log corresponds to a case that involves a past problem encountered in an industrial domain (e.g., power plant). Each case has a corresponding expert to which the case was assigned. Each of the case resolution logs includes textual data that includes information concerning the resolution of the case by the assigned expert. Accordingly, the textual data may, for example, include a name of the submitter, a name of the assignee, a description of the problem, and resolution information.

At operation 410, the topic modelling engine 200 extracts a plurality of topics from the case resolution data. The topic modelling engine 200 may extract topics from the case resolution data by applying text mining techniques to the textual data included in the plurality of case resolution logs that collectively form the case resolution data. In particular, the topic modelling engine 200 may extract words from each case resolution log and map each extracted word to a topic. In this way, each case log included in the corpus of case resolution data may be viewed as a mixture of various topics.

At operation 415, the topic modelling engine 200 constructs an expert-word matrix using the extracted plurality of topics. The expert-word matrix includes a row for each expert associated with the case resolution data and each entry of the row comprises the probability of the expert uttering (e.g., being associated with) a given word of the vocabulary associated with the case resolution data. Accordingly, the operation of constructing the expert-word matrix may include calculating a vocabulary for the case resolution data, and calculating, for each expert, a probability of the expert being associated with (e.g., uttering) a given word of the vocabulary through the topics derived from the case resolution data. The topic modelling engine 200 may construct the expert-word matrix using the extracted topics as hidden variables to model a relationship between experts and words belonging to a given topic. For example, the topic modelling engine 200 may use a natural language processing generative model such as LDA to model case logs, each of which is associated with an expert, as a mixture of topics, and represent each topic as a probability distribution over words.

FIG. 5 is a flowchart illustrating a method for identifying experts with expertise relevant to a user query, according to some example embodiments. The method 500 may be embodied in computer-readable instructions for execution by a hardware component (e.g., a processor) such that the steps of the method 500 may be performed, in part or in whole, by the functional components of the expert identification application 118, and accordingly, the method 500 is described below, by way of example with reference thereto. However, it shall be appreciated that the method 500 may be deployed on various other hardware configurations and is not intended to be limited to the expert identification application 118.

At operation 505, the interface module 204 receives a user search query (e.g., from the client device 106) describing a problem encountered in an industrial domain. For example, the user query may be generated by an engineer troubleshooting a technical problem caused by damage to a compressor blade. The user query may include one or more terms used to describe the problem.

At operation 510, the topic modelling engine 200 determines, for each expert of a plurality of experts associated with a corpus of case resolution data, a probability that the expert has expertise with the problem described by the user query. The topic modelling engine 200 may determine the probability that the expert has expertise with the problem described by the query based on a relationship between the one or more terms used to describe the problem and a plurality of topics extracted from the corpus of case resolution data. The topic modelling engine 200 determines the probability that the expert has expertise with the problem by using topics as hidden variables to model the relationship between user queries and experts. For example, as discussed above in reference to FIGS. 2 and 5, the topic modelling engine 200 may use a topic modelling technique such as LDA to extract topics from the corpus of case resolution data, and use the extracted topics to model the relationship between candidates and terms in a query.

At operation 515, the ranking engine 202 ranks the plurality of experts according to the respective probability that each expert has expertise with the problem described by the user query. At operation 520, the interface module 204 selects a subset of the plurality of experts for presentation to the user who submitted the query. For example, the interface module 204 may select the top three ranked experts for presentation.

At operation 525, the interface module 204 causes presentation of an expert selection interface on the client device 106 from which the user query was received. The expert selection interface includes graphical representations of the subset of experts (e.g., top three ranked experts) along with information about the experts that may assist the user's expert selection decision. The interface module 204 may cause the presentation of the expert selection interface by providing a set of instructions to the client device 106 that cause the client device 106 to display the expert selection interface to the user. From the perspective of the user of the client device 106, the user submits the query and in response, the expert selection interface is displayed.

FIG. 6 is an interface diagram illustrating an expert selection interface 600, according to an example embodiment. The expert selection interface 600 may be displayed on the client device 106 that is in communication with the application server 116. In some embodiments, the expert selection interface 600 may be accessed through an appropriate URL using the web client 108. In some embodiments, the expert selection interface 600 may be provided as one of several various interfaces provided the application 110.

As shown, the expert selection interface 600 includes a query field 602 for entering a user query to describe a problem being encountered in the field. A user (e.g., a technician 316) entering a query into the query field 602 may compose a free-form textual query, or select search terms from a predefined list of commonly used search terms. In response to receiving the user search query, the expert selection interface 600 provides a list of experts with relevant expertise in window 604. In this way, the expert selection interface 600 allows users to review the presented experts and select an expert to assist them with the problem. Further, users may instantly communicate with the selected expert using appropriate collaboration tools.

As shown, the window 604 includes information about each expert including a name 606, expertise 608, related cases 610, and rating 612. In this example, the expertise 608 of each expert includes a taxonomy-based representation of topic expertise that is query-independent. In particular, the expertise 608 is illustrated by a sunburst graphic created using taxonomy case tags used in case resolution logs. The sunburst graphic comprises a plurality of colored sections with each color corresponding to a particular case tag. The size of each section corresponds to the level of expertise of that expert in the corresponding case tag. The related cases 610 provide query-specific experience of the expert by listing a selection of relevant cases resolved by the expert along with links to the case resolution logs. The rating 612 displays an aggregate user rating of the expert, and allows users to rate the expert, such as on a five-star scale.

Further, the expert selection interface 600 also provides availability information for each expert including an online status 614, a location 616, and a local time 618. The expert selection interface 600 further includes a link 620 to each expert's enterprise social network profile where users can view the expert's organization chart, role, group affiliations, and social network contributions. The expert selection interface 600 also includes an indicator of how busy the expert is, such as the caseload 622 (e.g., number of currently assigned cases) for each expert.

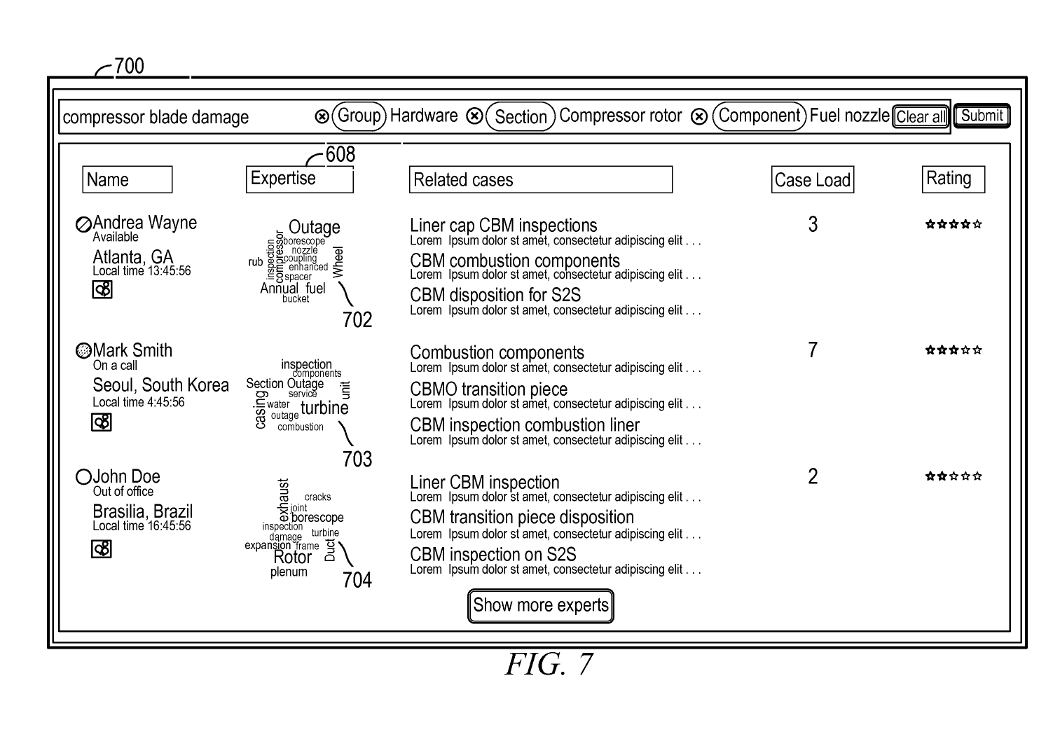

FIG. 7 is an interface diagram illustrating an expert selection interface 700, according to an alternative example embodiment. The expert selection interface 700 is substantially similar to the expert selection interface 600 with the exception of the depiction of the expertise 608 of each expert. In particular, in the expert selection interface 700, the expertise 608 of each expert is depicted by word clouds 702-704, respectively. Consistent with some embodiments, the word clouds 702-704 provide query-independent expertise information and are generated using top words (e.g., top 50) by LDA score. In some other embodiments, the word clouds 702-704 may be generated using the case titles used in case resolution logs assigned to the expert.

It shall be appreciated that the information illustrated in the expert selection interfaces 600 and 700 of FIGS. 6 and 7 is merely an example of expert information that may displayed, and in other embodiments more or less information may be displayed. For example, in some embodiments, the expert selection interface 600, 700 may include a number of years of experience of each expert or the languages the expert is proficient in.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 102 (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network 102.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture and Machine-Readable Medium

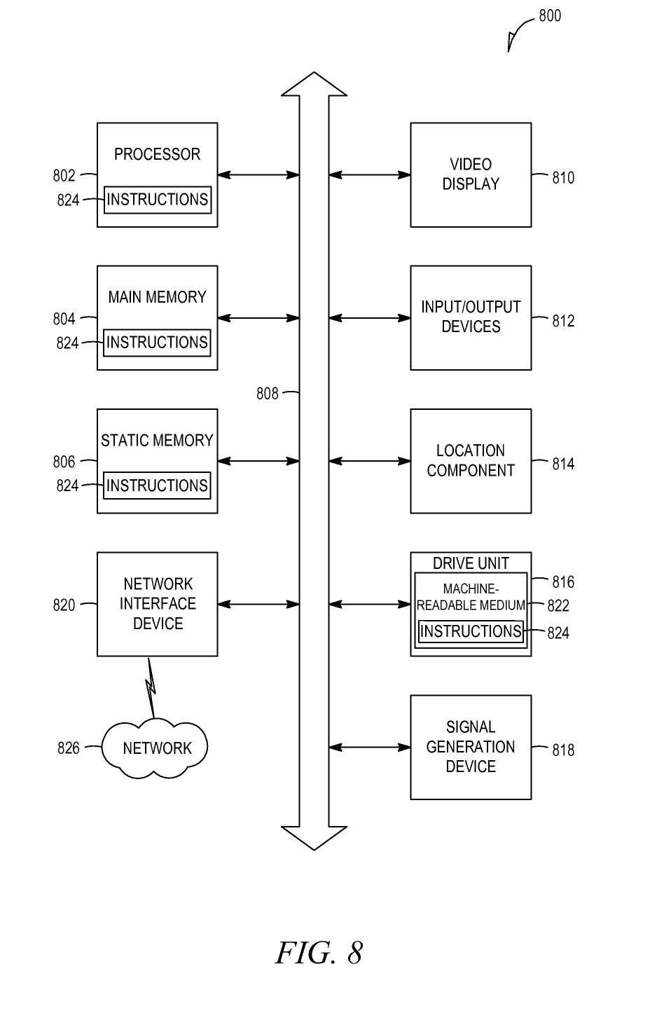

FIG. 8 is a diagrammatic representation of a machine in the example form of a computer system 800 within which a set of instructions for causing the machine to perform any one or more of the methodologies discussed herein may be executed. The computer system 800 may correspond to any one of the client device 106, the application server 116, the API server 112, or the web server 114, consistent with some embodiments. The computer system 800 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display 810 (e.g., a liquid crystal display (LCD) or a cathode ray tube (CRT)). The computer system 800 also includes one or more input/output (I/O) devices 812, a location component 814, a drive unit 816, a signal generation device 818 (e.g., a speaker), and a network interface device 820. The I/O devices 812 may, for example, include a keyboard, a mouse, a keypad, a multi-touch surface (e.g., a touchscreen or track pad), a microphone, a camera, and the like.

The location component 814 may be used for determining a location of the computer system 800. In some embodiments, the location component 814 may correspond to a GPS transceiver that may make use of the network interface device 820 to communicate GPS signals with a GPS satellite. The location component 814 may also be configured to determine a location of the computer system 800 by using an internet protocol (IP) address lookup or by triangulating a position based on nearby mobile communications towers. The location component 814 may be further configured to store a user-defined location in main memory 804 or static memory 806. In some embodiments, a mobile location enabled application may work in conjunction with the location component 814 and the network interface device 820 to transmit the location of the computer system 800 to an application server or third party server for the purpose of identifying the location of a user operating the computer system 800.

In some embodiments, the network interface device 820 may correspond to a transceiver and antenna. The transceiver may be configured to both transmit and receive cellular network signals, wireless data signals, or other types of signals via the antenna, depending on the nature of the computer system 800.

### Machine-Readable Medium

The drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, the static memory 806, and/or the processor 802 during execution thereof by the computer system 800, with the main memory 804, the static memory 806, and the processor 802 also constituting machine-readable media 822.

Consistent with some embodiments, the instructions 824 may relate to the operations of an operating system (OS). Depending on the particular type of the computer system 800, the OS may, for example, be the iOS® operating system, the Android® operating system, a BlackBerry® operating system, the Microsoft® Windows® Phone operating system, Symbian® OS, or webOS®. Further, the instructions 824 may relate to operations performed by applications (commonly known as “apps”), consistent with some embodiments. One example of such an application is a mobile browser application that displays content, such as a web page or a user interface, using a browser.

While the machine-readable medium 822 is shown in an example embodiment to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding, or carrying instructions (e.g., instructions 824) for execution by the machine and that cause the machine to perform any one or more of the methodologies of the present disclosure, or that is capable of storing, encoding or carrying data structures used by or associated with such instructions 824. The term “machine-readable medium” shall accordingly be taken to include, but not be limited to, solid-state memories, and optical and magnetic media. Specific examples of machine-readable media 822 include non-volatile memory including, by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium 822 is non-transitory in that it does not embody a propagating signal. However, labeling the tangible machine-readable medium 822 “non-transitory” should not be construed to mean that the medium is incapable of movement—the medium should be considered as being transportable from one real-world location to another. Additionally, since the machine-readable medium 822 is tangible, the medium may be considered to be a machine-readable device.

### Transmission Medium

The instructions 824 may further be transmitted or received over a network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, plain old telephone service (POTS) networks, and wireless data networks (e.g., WiFi and WiMax networks). The term “transmission medium” shall be taken to include any intangible medium that is capable of storing, encoding, or carrying the instructions 824 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A method comprising:
accessing a corpus of case log data, the case log data comprising a plurality of case resolution logs associated with a plurality of experts, each case resolution log of the plurality of case resolution logs being assigned to a particular expert of the plurality of experts and comprising textual data concerning a past problem encountered in an industrial domain;
extracting a plurality of topics from the case log data;
constructing an expert-word matrix using the plurality of topics extracted from the case log data, the expert-word matrix comprising, for each expert of the plurality of experts, a probability of the expert uttering each word belonging to a vocabulary of words in the case resolution data;
receiving, from a client device, a user search query describing a problem encountered in the industrial domain;
for each expert of the plurality of experts, determining a probability that the expert has expertise with the problem described by the user search query based on information in the expert-word matrix; and
causing presentation of expert selection interface on the client device, the expert selection interface including a list of a subset of the plurality of experts, the list being ranked according to the respective probability of each expert having expertise with the problem described by the user search query.

2. The method of claim 1, wherein the textual data includes a submitter name, an assignee name, a description of the previous problem, and resolution information.

3. The method of claim 1, wherein the extracting of the plurality of topics is based on a text mining analysis of the textual data.

4. The method of claim 1, wherein the extracting of the plurality of topics includes performing topic modeling on the textual data of the case log data.

5. The method of claim 4, wherein the performing of the topic modeling on the textual data of the case log data comprises:
modeling the textual data associated with each case of the plurality of cases as a mixture of topics; and
causing each topic to be represented as a probability distribution over words.

6. The method of claim 1, wherein the constructing the expert-word matrix comprises calculating, for each expert of the plurality of experts, the probability of the expert uttering the words in the search query.

7. The method of claim 1, wherein the presentation of the subset of the plurality of experts includes availability information for each expert, the availability information including an online status, a local time, a location, a list of related cases, and a current caseload.

8. The method of claim 1, wherein the presentation of the subset of the plurality of experts includes a representation of the expertise of each expert in the subset of experts.

9. The method of claim 1, wherein the representation of the expertise of each expert is a sunburst graphic, the sunburst graphic comprising a plurality of colored sections, each colored section of the plurality of colored sections corresponding to an area of expertise.

10. The method of claim 1, wherein the presentation of the subset of the plurality of experts includes one or more graphical elements operable to receive and display a rating for each expert of the subset of experts.

11. A system comprising:
a machine-readable medium storing a corpus case log data, the case log data comprising a plurality of case resolution logs associated with a plurality of experts, each case resolution log of the plurality of case resolution logs being assigned to a particular expert of the plurality of experts and comprising textual data concerning a past problem encountered in an industrial domain;
a topic modeling engine, comprising one or more processors, configured to extract a plurality of topics from the case log data, the topic modeling engine further configured to construct an expert-word matrix using the plurality of topics extracted from the case log data, the expert-word matrix comprising, for each expert of the plurality of experts, a probability of the expert uttering each word in a vocabulary of words in the case resolution data, the topic modeling engine further configured to determine a probability, for each expert of the plurality of experts, that the expert has expertise with a problem described by a user search query based on information in the expert-word matrix; and
an interface module configured to receive the user search query describing the problem, the interface module further configured to cause presentation of an expert selection interface on the client device, the expert selection interface including a list of the plurality of experts, the list being ranked according to the respective probability of each expert having expertise with the problem described by the user search query.

12. The system of claim 11, further comprising a ranking module configured to rank the plurality of experts according to the respective probability of each expert having expertise with the problem described by the user search query.

13. The system of claim 11, wherein the textual data includes a submitter name, an assignee name, a description of the previous problem, and resolution information.

14. The system of claim 11, wherein the topic modeling engine is configured to extract the plurality of topics based on a text mining analysis of the textual data.

15. The system of claim 11, wherein the topic modeling engine is configured to extract the plurality of topics by performing Latent Dirichlet Allocation (LDA) modeling on the textual data of the case log data.

16. The system of claim 15, wherein the performing of the LDA modeling on the textual data of the case log data comprises:
modeling textual data associated with the plurality of cases as a mixture of topics; and
causing each topic to be represented as a probability distribution over words.

17. The system of claim 11, wherein the topic modeling engine is configured to configured to construct an expert-word matrix by performing operations comprising calculating, for each expert of the plurality of experts, the probability of the expert uttering the words in the search query.

18. The system of claim 11, wherein the expert selection interface includes availability information for each expert, the availability information including an online status, a local time, a location, and a current caseload.

19. The method of claim 1, wherein the presentation of the subset of the plurality of experts includes a word-cloud corresponding to each expert, the word-cloud comprising a plurality of words from the case corpus that the expert is most likely to utter.

20. A non-transitory machine-readable storage medium embodying instructions that, when executed by at least one processor of a machine, cause the machine to perform operations comprising:
accessing a corpus of case log data, the case log data comprising a plurality of case resolution logs associated with a plurality of experts, each case resolution log of the plurality of case resolution log being assigned to a particular expert of the plurality of experts and comprising textual data concerning a past problem encountered in an industrial domain;
extracting a plurality of topics from the case log data;
constructing an expert-word matrix using the plurality of topics extracted from the case log data, the expert-word matrix comprising, for each expert of the plurality of experts, a probability of the expert uttering each word belonging to a vocabulary of words in the case resolution data;
receiving, from a client device, a user search query describing a problem encountered in the industrial domain;
for each expert of the plurality of experts, determining a probability that the expert has expertise with the problem described by the user search query based on information in the expert-word matrix; and
causing presentation of expert selection interface on the client device, the expert selection interface including a list of the plurality of experts, the list being ranked according to the respective probability of each expert having expertise with the problem described by the user search query.
